(19) United States
(12) Patent Application Publication
(10) Pub. No.: US 2026/0249515 A1
(43) Pub. Date: Aug. 27, 2026

(54) SYSTEMS AND METHODS RELATED TO DEMOLDING CAST PRODUCTS

(71) Applicant: SILVERMINE STONEOPERATING CO L.L.C., EAU CLAIRE, WI (US)

(72) Inventors: MICHAEL PRESTON BOROM, WESTPORT, CT (US); JASON FEATHERLY, ELEVA, WI (US); ANTHONY MICKELSON, ALTOONA, WI (US); DANIEL UEBELE, WEST SALEM, WI (US); RICHARD LICHTIE, MELROSE, WI (US)

(21) Appl. No.: 19/548,287

(22) Filed: Feb. 24, 2026

Related U.S. Application Data
(60) Provisional application No. 63/834,116, filed on Feb. 24, 2025.

(51) Int. Cl. B28B 13/06; B28B 7/06

(52) U.S. Cl. CPC B28B 13/06; B28B 7/06

(57) ABSTRACT

Systems and methods are configured to separate a flexible mold from a sufficiently cured cast product at least partially contained in the mold. A clamp receives a portion of the mold and secures it relative to a drum. The drum rotates to cause separation of the mold from the cast product. A separated mold and separated cast product are translated or conveyed to separate locations for further processing.

### BACKGROUND

This invention relates to systems and methods for removing a mold from cast products. As known in the art, mortarless stone panels refer to an artificial stone siding product made from cement aggregate cast into panels. These panels are designed to replicate the appearance of natural stone through a combination of molding and surface painting during the casting process. Some stone panels are installed using traditional adhesives, while others incorporate integrated mounting supports (such as flashing) inserted into the stone during casting. These supports extend from at least one edge of the stone body, allowing the panels to be securely fastened to a building's exterior. This latter application enables quick and efficient wall construction, similar to the installation of standard lap siding.

During production, stone (or other material) is cast in a flexible mold 10 (see FIG. 1), which is housed in a rigid carrier 30 (see FIG. 3) throughout a curing process. The carriers 30 may be relatively aligned in a stack on a shipping pallet (not shown), for example. Stone panels generally have predefined lengths 12 and widths 14, with each mold 10 capable of receiving a casting media to form two or more panels. Voids 16a,b in the mold 10 generally define the panel length 12 and the panel width 14, and may provide a textured bottom surface. Voids are generally arranged in a side-by-side orientation within the mold 10 (see FIG. 1 for the layout of a two-panel mold). This orientation is preferred as it ensures smooth concrete dosing while protecting any protruding structure (e.g., attachment system or flashing) from bending or disturbance during production, curing, and removal from the mold. Once the molded media (e.g., stone) is cured, the mold 10 and cast product 18 are removed from the carrier 30, and the product 18 (with support structure 20) is extracted from the mold 10—a process that is often performed manually. Efficient removal without damaging the mold 10, attachment system/flashing 20, or the cast product 18 itself is preferred for maintaining high-speed production and profitability at scale.

Existing methods for removing a cast product 18 from a mold 10 range from manual extraction, where the mold 10 is physically (by hand) pulled away from the product, to automated approaches. One common automated method involves supporting the mold stone-side (i.e., face-down) on a parallel rail system, with mold edges resting on the rails. A roller or wheel then applies downward pressure across the middle of the mold while moving along its length. Such pressure can be applied along a length by respectively moving one or both of the roller and mold. The applied pressure flexes the mold, causing the stone to release and drop onto a conveyor positioned beneath the mold edge rails. However, in cases where the stone panel includes an integrated flashing or attachment system 20, this method is not feasible. The flashing 20 is embedded in an edge of each product 18 and extends beyond the mold edges (see FIG. 2), making it incompatible with rail support systems and obstructing the demolding process.

Accordingly, improved at least partially automated devices and methods for demolding cast products are desirable.

### SUMMARY OF THE INVENTION

Systems and methods according to the present invention provide improvements for removing a casting mold from one or more cast products. Such systems and methods utilize a rotating drum mechanism with an integrated clamp system. This method enables controlled separation of cast products from flexible molds by utilizing a large drum device to gently peel the mold away from the product. This approach attempts to reduce potential damage to both the stone and the mold while streamlining production.

According to an aspect of an embodiment of a system according to the present invention includes a drum configured to rotate about a drum axis disposed perpendicular to a first direction of travel of a flexible mold at least partially containing a cast product (e.g., cementitious product such as stone veneer). A clamp supported on the drum, the clamp being configured to secure a leading edge of the mold relative to the drum. When the drum rotates with a mold clamped thereto, the mold is bent, causing an outwardly radially facing surface to extend and an inwardly radially facing surface to compress slightly.

According to another aspect of an embodiment of a system according to the present invention, once a mold is separated from a cast product, the mold and cast product may be conveyed, transported or otherwise relayed for further processing. The mold may be conveyed along a first transfer path and the product may be conveyed along a second transfer path, the first and second transfer paths being preferably distinct. The second transfer path may be disposed substantially vertically below the first transfer path.

According to yet another aspect of an embodiment of a system according to the present invention, the cast product to be separated from its mold may include structural support members (e.g., rebar or flashing, such as aluminum flashing) extending from a lateral side thereof, and possibly at least partially embedded therein. The extension may be substantially perpendicular to the first direction of travel.

According to still another aspect of an embodiment of a system according to the present invention, the clamp may include a first piston and a second piston with a jaw extending therebetween. The pistons are configured to reciprocally move to cause movement of the jaw radially outwardly and inwardly relative to the drum. The pistons are preferably mounted at or near opposite ends of the drum, and the jaw preferably extends at least substantially parallel to the drum axis.

A process according to the present invention preferably includes a coordinated flow of molds (including cast product, sufficiently cured) with proper orientation, separation of a mold from its carrier, separating cast product (e.g., stone veneer panels) from a mold, sending the mold to be rejoined with the same or a different carrier for subsequent reuse and cast product final inspection and packaging.

The process begins with a mold at least partially containing a cast product being separated from a mold carrier and positioned product-side down on a conveyor. The carrier may be diverted onto a separate transfer path or conveyor line to eventually be reused with a mold after the cast product (e.g., stone veneer panel) is removed therefrom, or another mold. The product-side-down mold is then correctly oriented and transported along the conveyor beneath a suspended demolding drum (or in some other direction whereby the drum is positioned to receive the closed side of the mold). The leading edge of the flexible mold is engaged by a clamping mechanism, securing it to the drum. As the drum rotates, it progressively lifts and rolls the mold away from the stone panel, ensuring that the stone and its integrated attachment/flashing system remain undisturbed on the conveyor.

Once fully separated, the mold is discharged onto a first conveyor for collection and reuse, while the cast product is conveyed in a second path that is preferably vertically lower than the mold discharge path. The cast product may undergo a 90-degree rotation (or other angle rotation) to align it with its next steps in the production line. This rotation is optional and is implemented only when necessary to align the panels with the flow of the conveying system. The stone panel then continues through the production line for further processing, including inspection, boxing, and finishing.

Embodiments according to the present invention enhance efficiency and reliability in the demolding process. By utilizing a rolling motion, the system attempts to provide a substantially uniform release along the entire mold length, preventing excessive pressure that could cause stone breakage and may extend the useful life of molds.

Automating the extraction process significantly reduces physical strain associated with manual demolding, a task known for its high labor demands when done manually. The drum design is optimized to accommodate various mold sizes, having an outside circumference of preferably approximately 2.5 to 3 times the mold length provides effective separation. However, this ratio is adaptable based on specific production needs.

Additionally, the system is highly versatile, supporting both standard molds and those with embedded flashing, which are typically incompatible with traditional rail-based demolding methods.

### BRIEF DESCRIPTION OF THE DRAWINGS

FIG. 1 is a top plan, perspective view of an empty mold.

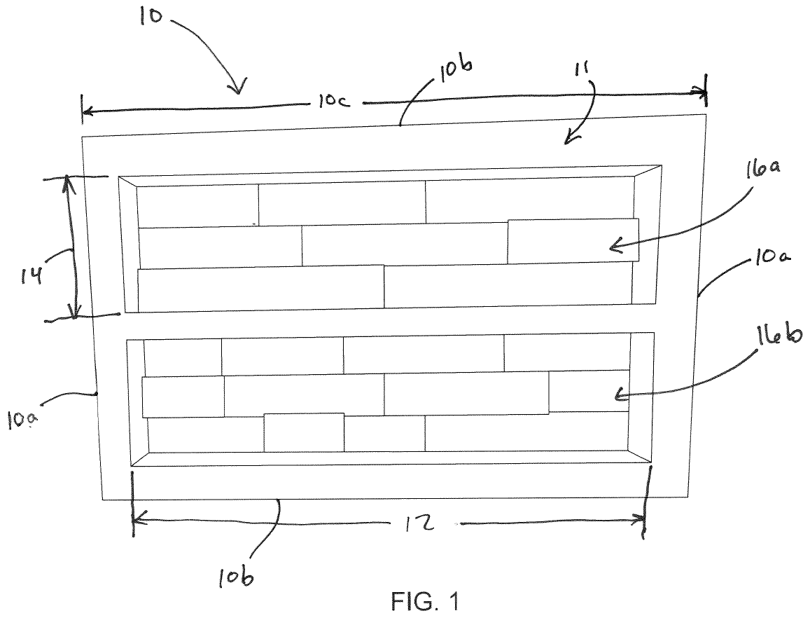

FIG. 2 is a top plan perspective view of the mold according to FIG. 1, having received mold media.

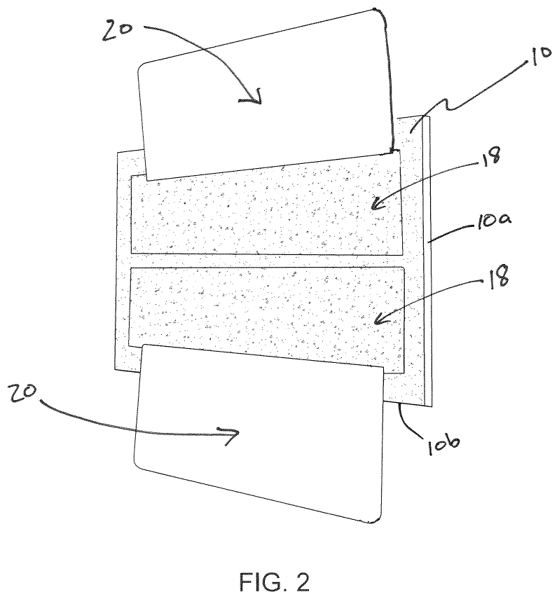

FIG. 3 is a perspective view of a mold carrier.

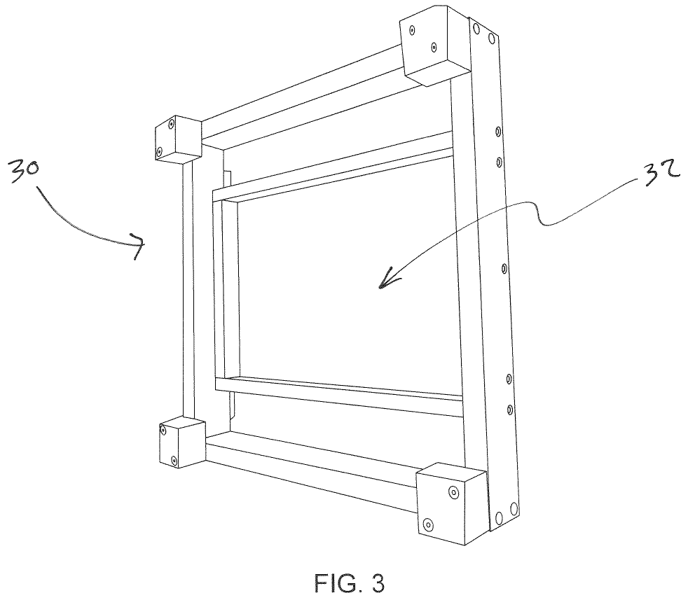

FIG. 4 is a top plan view of an embodiment of a system according to the present invention.

FIG. 5 is a partial cutaway downstream right perspective view of the embodiment of FIG. 4 with a drum in a loading position.

FIG. 6 is a partial cutaway upstream right perspective view of the embodiment of FIG. 4 with the drum in the loading position.

FIG. 7 is a first partial cutaway right elevation view of the embodiment of FIG. 4.

FIG. 8 is a second partial cutaway right elevation view of the embodiment of FIG. 4.

FIG. 9 is a partial cutaway upstream left perspective view of the embodiment of FIG. 4 with the drum in a peeling position.

FIG. 10 is a second partial cutaway downstream right perspective view of the embodiment of FIG. 4, with the drum in the peeling position.

FIG. 11 is a third partial cutaway right elevation view of the embodiment of FIG. 9.

FIG. 12 is a fourth partial cutaway right elevation view of the embodiment of FIG. 9.

### DETAILED DESCRIPTION

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention.

Generally speaking, in casting, a mold 10 having voids or cavities 16a,b is filled with a casting media (e.g., concrete, metal, plastic), which may be poured in through an open top surface 11, the media is allowed to cure into a shape defined by the mold 10, resulting in a cast product 18. The cast product 18 may include embedded structure extending therefrom, such as mounting structure or flashing 20.

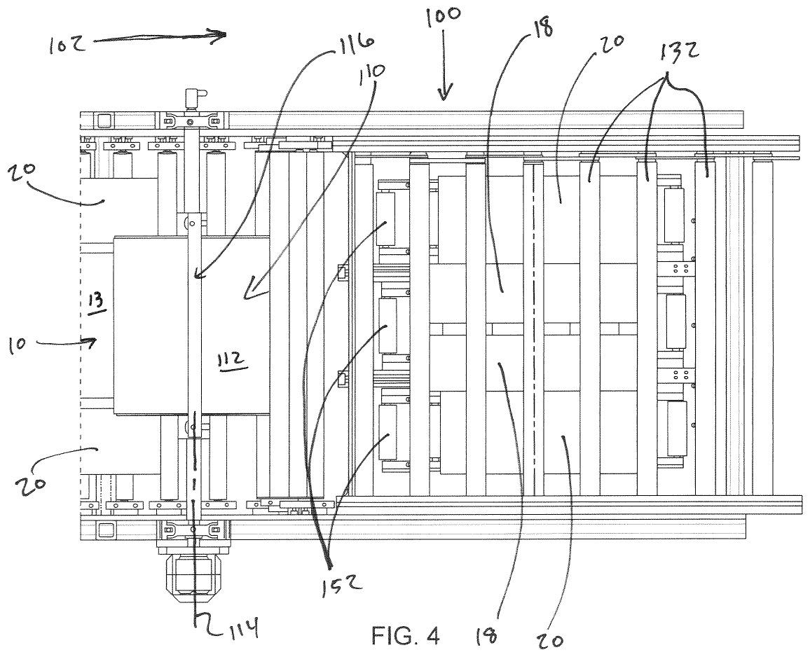

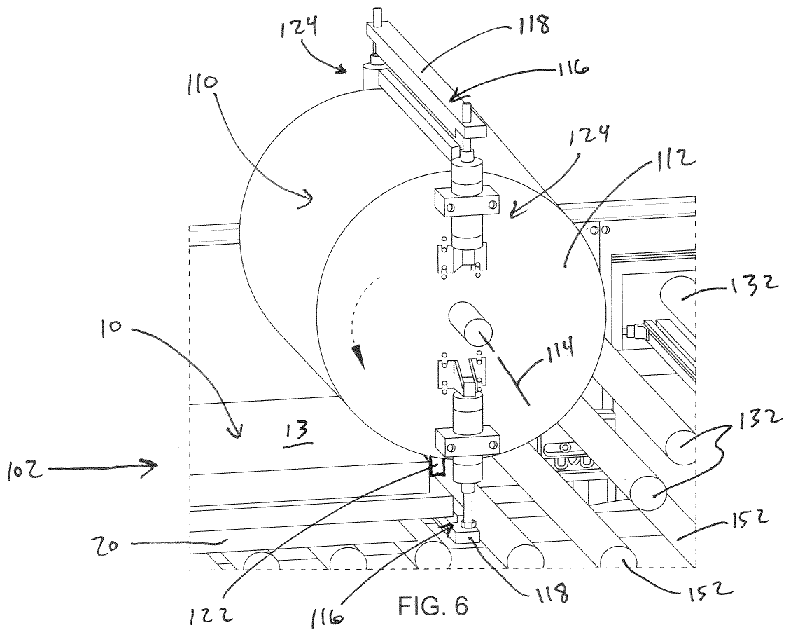

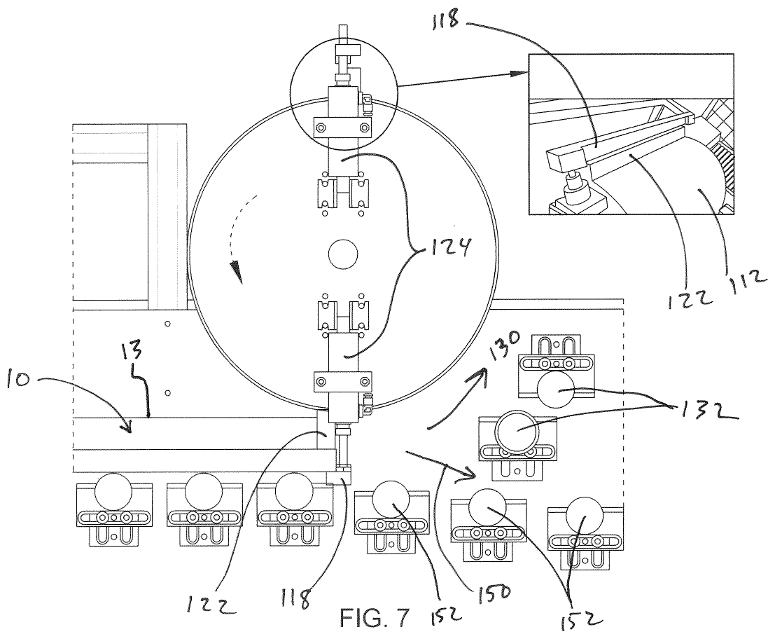

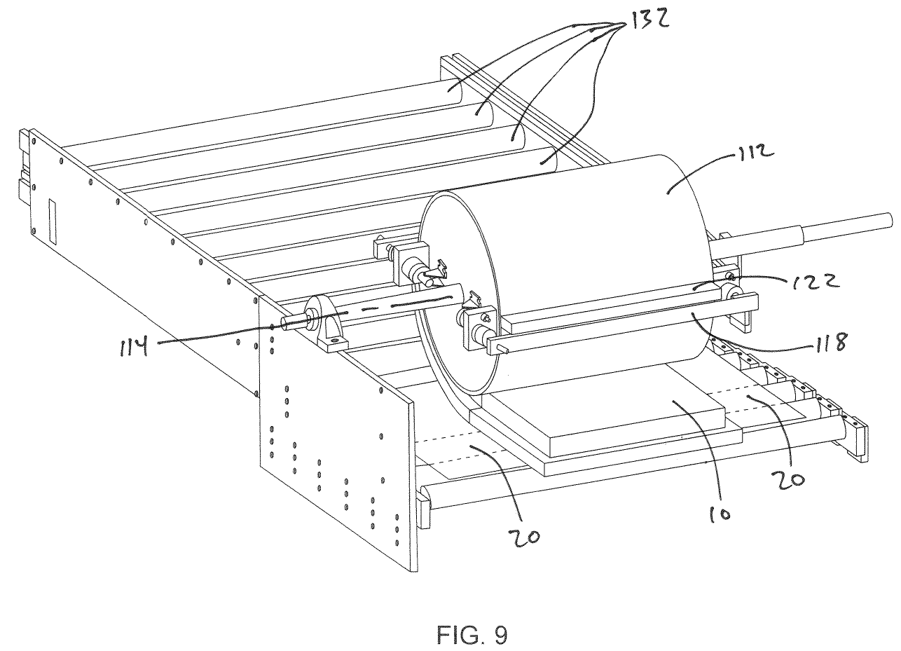

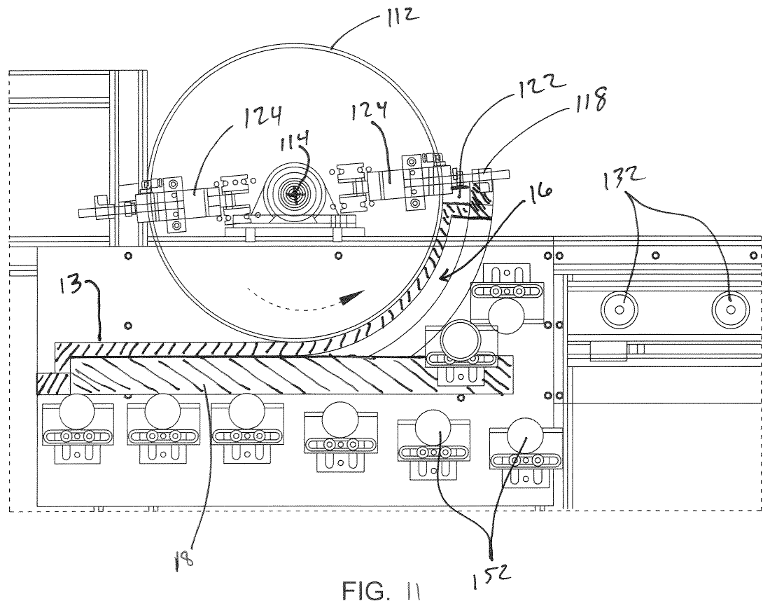

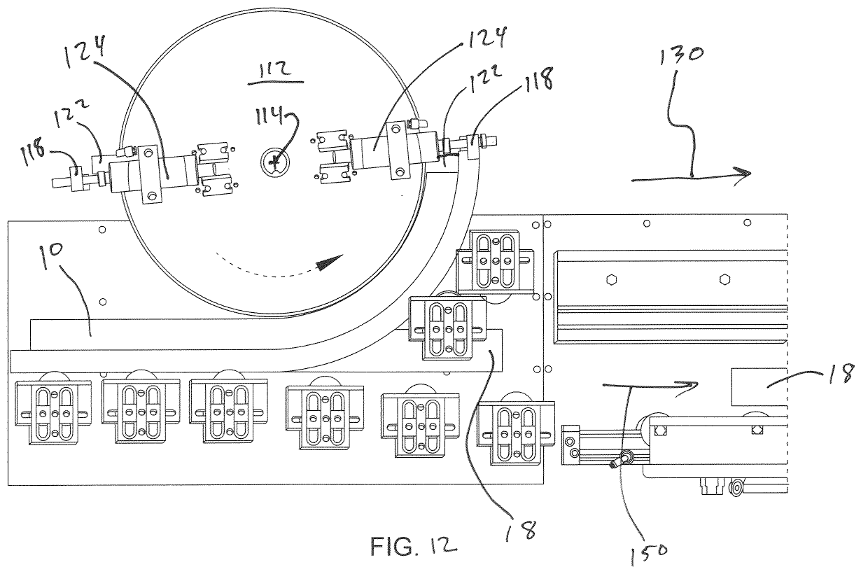

A system 100 according to the present invention can be seen in FIGS. 4-13. Generally, the system 100 preferably includes a mold peeler 110, a first conveyor (or first transfer path) 130, and a second conveyor (or second transfer path) 150. The system 100 receives a mold 10 (travelling in a first mold travel direction 102) including a cast product 18 (after sufficient curing). The mold peeler 110 grasps the mold 10, causing separation of the cast product 18 therefrom. The mold 10 is conveyed along (or travels along) the first transfer path 130 and the cast product 18 is conveyed along (or travels along) the second transfer path 150, which is preferably separated from the first transfer path 130. The process is repeated serially for additional molds 10 in queue.

A preferred mold peeler 110 includes a drum 112 (having an at least substantially circular or polygonal cross-section) with a substantially cylindrical, imperforate external surface configured to be driven about a drum axis 114 disposed generally perpendicular to the first mold travel direction 102. The drum 112 includes an outer drum circumference radially extending about the drum axis 114 that is preferably at least equal to, but is preferably greater than, a length 10c of a mold 10 to be used in connection therewith. More preferably the outer drum circumference is at least twice the length 10a, and is more preferably approximately three times the mold length 10a. The drum 112 has at least one clamping mechanism 116 disposed thereon, the clamping mechanism 116 extending preferably along a majority of a length of the drum 112, preferably substantially parallel to the drum axis 114. The clamping mechanism 116 preferably includes a movable jaw 118, moveable from an open position 118a (the jaw 118 being disposed radially outwardly spaced) to a closed position 118b (the jaw 118 being disposed radially inwardly spaced). The movable jaw 118 thus works to accept or release a mold 10 when in the open position 118a and works to secure a portion of the mold 10 to the drum 112. A fixed jaw 120 may be provided in the form of a fence 122, or an external surface of the drum 112 may serve as the fixed jaw portion of the clamping mechanism 116. While the movable jaw 118 may be manually positionable, the jaw 118 is preferably moved by one or more actuators 124. The actuators 124 may be, for example, normally open electrical solenoids with plunger rods or pistons, the free end of which is coupled to the movable jaw 118. A first actuator 124 may be supported on one end of the drum 112, and a second actuator 124 may be supported on a second end of the drum 112, with the jaw 113 spanning the distance therebetween. As shown, a preferred drum 112 supports two clamping mechanisms 116, which are approximately diametrically opposed on opposite sides of the drum 112 and drum axis 114. Where multiple clamping mechanisms 116 are used, they (that is, the movable jaws 118 of circumferentially adjacent clamping mechanisms 116) are preferably circumferentially spaced about the drum 112 by a distance that is at least as great (and more preferably slightly greater than) the void length 12 as further including mold thickness and provided along the direction of the void length 12 along the bottom surface 13 of the mold 10. The movable jaw 118 preferably includes elements along its length, such as a ridge, a series of ridges, or other stress risers that may focus clamping forces along or at particular discrete locations along such length.

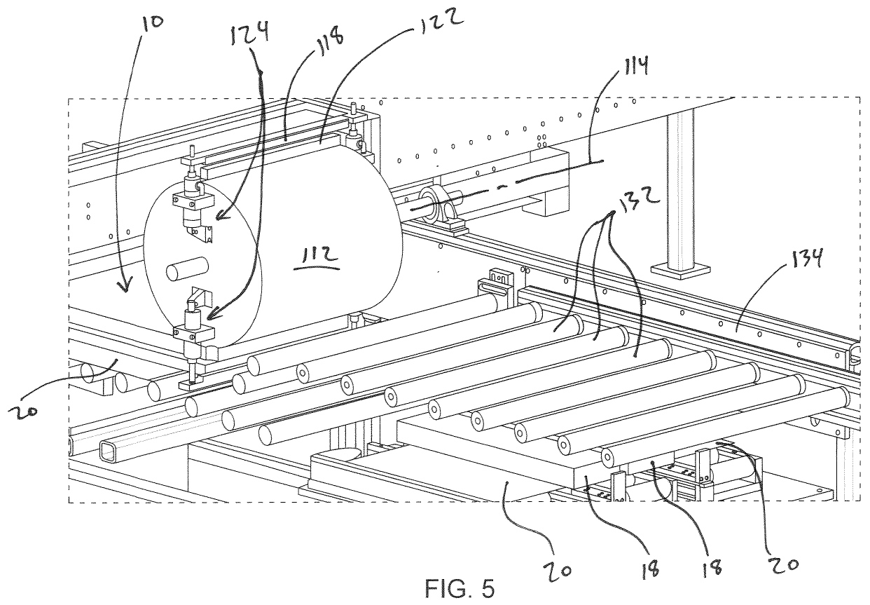

The first transfer path 130 is preferably defined by a plurality of rollers 132, which may be rotatably supported on each end by a frame 134 (partially removed in FIG. 5). The rollers 132 may be passive, or they may be actively driven to automatically convey a mold 10 (after separation from cast products 18) along their path. Other conveyors will be readily apparent to those with skill in the art, including belts.

The second transfer path 150 is preferably defined by a second plurality of rollers 152, which may be rotatably supported on each end by a frame 154 (partially removed in FIG. 5). The rollers 152 may be passive, or they may be actively driven to automatically convey a cast product 18 (after separation from a mold 10) along their path. Other conveyors will be readily apparent to those with skill in the art, including belts.

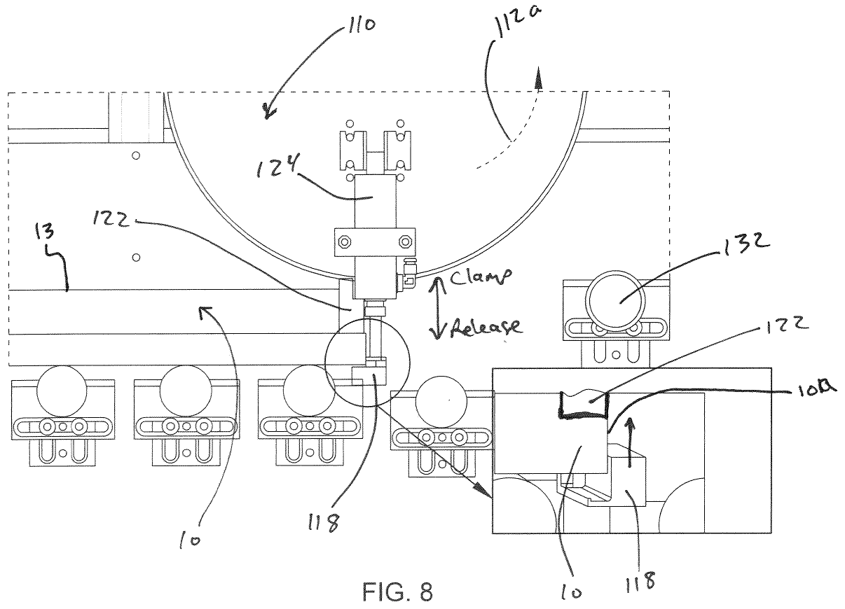

With reference to FIGS. 4-5, a first set of cast products 18 have been removed from a mold (not shown), and are disposed in the second transfer path 150 on rollers 152 downstream from the drum 112, situated vertically below the first transfer path 130 including rollers 132. A second mold 10 is moving in the transfer direction 102, below the drum 112. The position of the drum 112 shown in FIGS. 4-8 may be referred to as a loading rotational position. In this position, a clamping mechanism 116 is located vertically proximately the bottom of the drum 112. In this position, the movable jaw 118 of the clamping mechanism 116 is opened, such as by deenergizing (or energizing) actuators 124 allowing or causing the movable jaw 118 to move radially away from the drum 112. The mold 10 is translated in the first transfer direction 102, preferably until the mold engages a stop, or registration member, which may be a portion of the movable jaw 18, a portion of the fence 122, or a combination thereof. Alternatively, a stop member may not be utilized as long as the mold 10 is positioned sufficiently to be secured to the drum 112 by the clamping mechanism 116. Once the mold 10 (with product 18) is positioned for clamping, the movable jaw 118 is energized (or deenergized) causing or allowing the movable jaw 118 to move in a clamping direction (118a, FIG. 8), so as to pinch the mold 10 between it and a nonmovable clamping jaw, such as the fence 122 and/or an external surface of the drum 112. The clamping mechanism 116 preferably does not secure the product 18 to the drum 112, and even more preferably refrains from contacting the product 18 and/or support members 20 altogether.

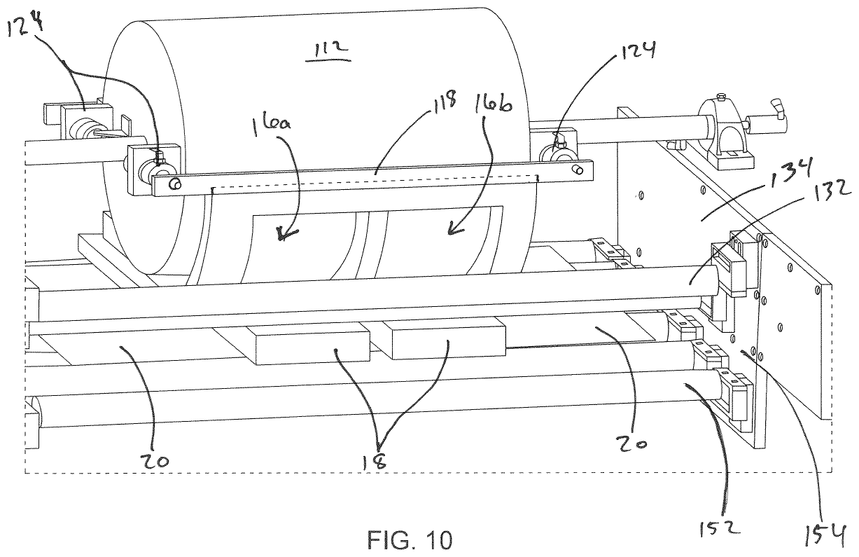

After clamping, the drum 112 is rotated about the drum axis 114, moving the clamping mechanism 116 that has engaged the mold 10 in a generally circumferential upward direction 112a. In such manner, the mold 10 is peeled up and away from product 18 and supporting structure 20 that is allowed (largely by gravity) to travel downward along rollers 152 to the second transfer path 150, as can best be seen in FIG. 10. This controlled separation reduces or eliminates concentrated pressure points, which could otherwise lead to breakage, especially in longer cast products (e.g., stone panels). The drum 112 continues rotating until the mold 10 is completely detached from the product 18. The drum 112 continues rotating, with the leading edge 10a clamped to the drum 112, until the trailing edge of the mold 10 clears the most upstream first transfer path roller 132, thereby allowing the trailing edge to flip upwards to a position above the first transfer path rollers 132. The mold trailing edge thus becomes the leading edge and flipping the open mold side 11 generally upwards. The mold bottom or closed side 13 is thus generally positioned downwards. The drum 112 then briefly reverses direction (counter to 112a) to cause the new mold leading edge to move along the first transfer path and the bottom or closed side 13 translating across the first transfer path rollers 132. Once the mold 10 center of gravity is preferably positioned downstream of the most upstream first transfer path roller 132, the clamping mechanism 116 is released to allow the mold 10 to separate completely from the drum 112, oriented open side 11 up, onto the rollers 132. The mold 10 preferably advances toward a cleaning and reloading station, where it will be rejoined with a carrier 30 (this step can be manual or automated). The carrier 30 may be the same carrier from which the mold 10 and product 18 was removed, or it may be a different one.

The released cast products 18 (e.g, stone panel(s)) travel along the second transfer path 150, which may be defined beneath (vertically below) the first transfer path 130. The product 18 is then preferably transported or conveyed to a final inspection and packaging line or location.

After the clamping mechanism 116 releases the mold 10 into or onto the first transfer path 130, the drum 112 rotates to a next loading rotational position, resetting the next clamping mechanism 116 to receive a subsequent mold 10 and product 18 to be released.

A system according to the present invention may further include other material handling elements. For instance, where mold carriers 30 are stacked on a conventional shipping pallet, a depalletizer may be used to select a carrier 30 and supported mold from the stack (bottom or top). This module, commonly used in industrial applications, removes the mold carrier 30 containing the mold 10 and cast product 18 from a stacked inventory, typically ranging from six to ten units high. A gripper and lift system secures and raises the stack, allowing the bottom mold carrier to be separated and transported using a forklift-style device for further processing. The molds 10 and carriers 30 are stacked in a manner that ensures the attachment/flashing system 20 does not obstruct a depalletizer's vertical posts, allowing for smooth and efficient operation.

When stacked, molds 10 are usually disposed with a side up that allows access to the voids 16. That is, casting media is poured into the mold 10 and voids 16 through an open top surface 11. In a system as described above, where the drum 112 is positioned vertically above a travel path of a mold 10 containing cast product 18, it is thus preferable to flip a mold 10 (vertically 180 degrees) to place the open top surface 11 of the mold 10 face down. Once removed from the stack, each carrier 30 and mold 10 combination (where mold bottom surface 13 is generally received in a carrier cavity 32) preferably undergoes a controlled flipping process, to place the open top surface 11 vertically below the opposite mold bottom surface 13. The carrier 30, including the mold 10 and cast product 18 is preferably supported from below (vertically) with a forklift-style device. A secondary lift paddle system may secure the carrier 30 (with mold 10) from above, preferably with paddle orientation being perpendicular to the long edge 10b of the mold 10 to ensure the cast products 18 remain supported during the flipping process. The carrier/mold combination is inverted so that the mold top surface 11 is positioned face-down. A rotating table may be used to align the upside down mold 10 to travel in a substantially linear direction towards the drum 112, preferably aligning a leading edge (preferably a short edge 10a of the mold 10) substantially parallel to the drum axis 114. The carrier 30 is then preferably removed from the mold 10. While the carrier 30 may be manually removed, a mechanical arm preferably grasps and lifts the carrier 30 separating it from the mold 10. The carrier 30 is then preferably transported and reoriented at a distal end of the first transfer path 130, where it is preferably flipped back to its original orientation and prepared to be rejoined with an empty mold 10.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention. For example, while the system 100 according to the present invention disposes a peeling drum 112 vertically above the translation path of a mold 10 and product 18. It will occur that such orientation may be advantageous to utilize gravity as a product separation force, the system could be oriented in any configuration such that the drum 112 is aligned on the closed mold side 13, such that the closed side 13 is generally maintained in contact with an outer circumference of the mold 10 during the rotation that separates product 18 from the mold 10. Additionally or alternatively, though a preferred drum 112 has been described as having a generally cylindrical, imperforate outer surface, it is to be understood that modifications to the drum may be made, so long as during rotation of the drum 112 while a mold 10 is clamped thereto, there are surfaces of the drum 112 that contact the bottom surface 13 of the mold 10 at discrete locations or continuously throughout such rotations.

What is claimed is:

1. A system comprising:
a drum configured to rotate about a drum axis disposed perpendicular to a first direction of travel of a flexible mold at least partially containing a cast product; and
a clamp supported on the drum, the clamp being configured to secure a leading edge of the mold relative to the drum.

2. The system according to claim 1, further comprising a first conveyor for accepting a cast product released from the mold.

3. The system according to claim 1, further comprising a second conveyor for accepting the mold.

4. The system according to claim 1, wherein the cast product includes structural support members extending from a lateral side thereof, substantially perpendicular to the first direction of travel.

5. The system according to claim 1, the structural support members comprising flashing.

6. The system according to claim 3, the flashing being at least partially embedded in the cast product.

7. The system according to claim 4, the flashing being formed from an aluminum sheet material.

8. The system according to claim 1, wherein the clamp comprises:
a first piston reciprocally movable along a first longitudinal path from a first piston retracted position to a first piston extended position;
a second piston reciprocally movable along a second longitudinal path from a second piston retracted position to a second piston extended position;
a jaw longitudinally extending from a first end coupled the first piston to a second end coupled to the second piston.

9. The system according to claim 8, wherein the first piston is disposed at a first end of the drum and the second piston is disposed at a second end of the drum, opposite the first, the jaw extending substantially parallel to the drum axis.

10. The system according to claim 1, wherein the cast product comprises a cementitious cast product.

11. The system according to claim 1, wherein the cast product comprises a stone veneer.

12. A method comprising the steps of:
providing a flexible mold having an open top surface, a closed bottom surface, at least one molding void extending therebetween, and an at least partially cured cast product being disposed in the at least one molding void;
arranging the closed bottom surface against an outer circumference of a drum;
securing a leading edge of the mold relative to the drum; and
after the securing step, rotating the drum to cause extension of the open top surface and compression of the closed bottom surface, thereby at least partially separating the mold from the cast product.

13. The method according to claim-1, the method further comprising the step of: continuing rotation of the drum until the cast product is completely separated from the mold.

14. The method according to claim-1, further comprising the steps of:
translating the mold along a first transfer path; and
translating the cast product along a second transfer path.

15. The method according to claim-1, whereby the first transfer path is different than the second transfer path.

16. The method according to claim-1, whereby the first transfer path is defined vertically above the second transfer path.

17. The method according to claim 14, further comprising the steps of:
continuing rotation of the drum until the mold is positioned for deposit in the first transfer path;
after the mold is positioned for deposit in the first transfer path, releasing the leading edge relative to the drum; and
reversing rotation of the drum sufficiently to cause the mold to freely enter the first transfer path.
